(19) United States
(12) Patent Application Publication
(10) Pub. No.: US 2007/0000054 A1
(43) Pub. Date: Jan. 4, 2007

(54) Sanitary massage bath

(76) Inventor: John M. Fanuzzi, Emigrant, MT (US)

Correspondence Address: Dennis A Bennett, 2 Hogan Circle- 208, Eureka, MO, 63025, US

(21) Appl. No.: 11/434,430

(22) Filed: May 15, 2006

Related U.S. Application Data
(60) Provisional application No. 60/680,574, filed on May 13, 2005.

(51) Int. Cl. A61H 9/00

(52) U.S. Cl. 5/606; 601/158; 601/154; 4/622

(57) ABSTRACT

There is disclosed an invention that provides a tub or footbath capable of receiving one or both of a patient's feet within the leg section of a table or chair and an indirect means to provide turbulent water to massage the feet.

### RELATED APPLICATION(S)

This Application claims priority of U.S. provisional application Ser. No. 60/680574 filed May 13, 2005.

### FIELD OF THE INVENTION

The present invention relates to tables or pedicure chairs with water massage footbaths.

### BACKGROUND OF THE INVENTION

There is also disclosed in the art numerous chairs for a patient to sit and place the feet in a bath. U.S. Des. Pat. No. 429,380 and U.S. Des. Pat. No. 429,370 both disclose a pedicure chair design for this purpose. U.S. 4,075,457 discloses a bench unit with a variety of compartments of such a height to enable a seated patient to rest the feet in the open compartments. The compartments are fitted with removable feet bath tubs.

U.S. Pat. No. 6,739,003 disclose tables with footbaths in the leg section.

A major disadvantage of the prior massage tables or pedicure chairs with foot baths is that they the systems used to create the water flow is not sanitary. After one patient uses the prior art systems it must be cleaned with harsh chemical to ensure that the next patient is not infected with what ever disease the prior patient might have had.

The present invention solves this problem by allowing for compete sanitary conditions and to have the massage function in the foot bath or pedicure chair without the massage system needing to be cleaned after each use.

### SUMMARY OF THE INVENTION

The instant invention provides a system including tub or footbath capable of receiving one or both of the patient's feet within the leg section of the table and a means to provide turbulent water is massage the feet. The water agitating device indirectly agitates the water to provide the massaging effect. This greatly reduces the time to clean the footbath for the next patient since the water is contained in the tub and will not containment any of part of the massage system.

### BRIEF DESCRIPTION OF THE DRAWINGS

FIG. 1 shows the footbath being used in a massage table with a liner inside the tub.

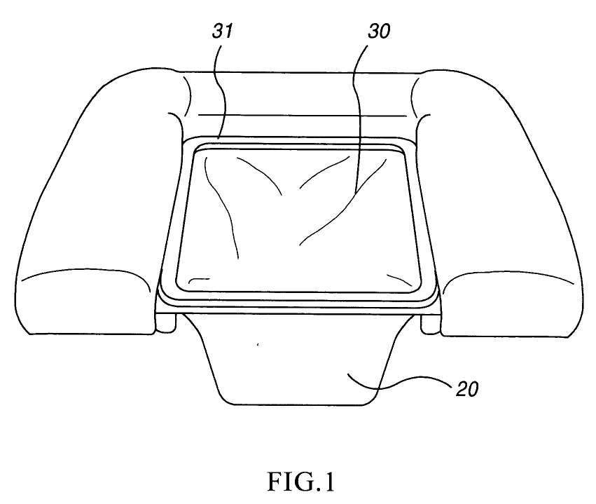

FIG. 2 shows the indirect agitator hooked to the underside of the tub.

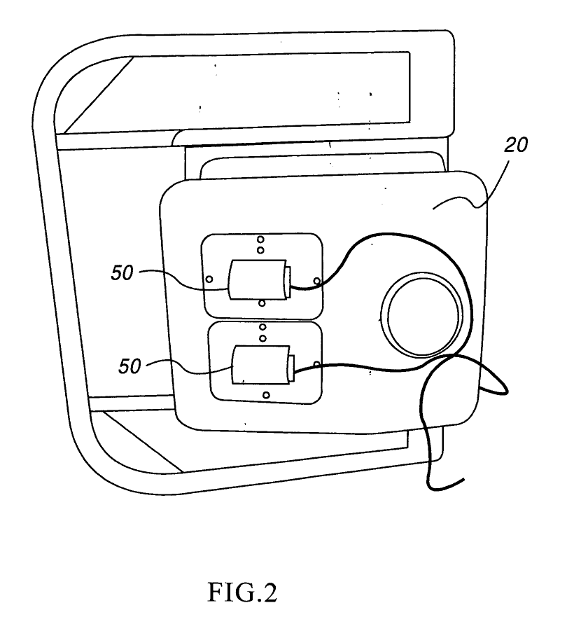

FIG. 3 shows a chair version with the tub in a separate cart.

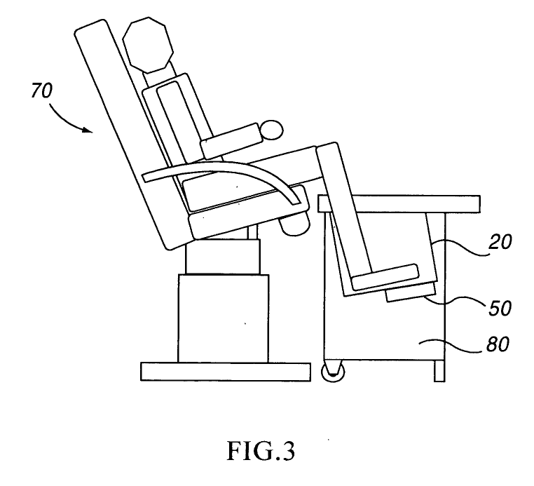

### DETAILED DESCRIPTION OF THE PREFERRED EMBODIMENTS

Unlike current art in the professional pedicure industry that uses water jets or air pumps to create a stimulating experience on the feet working directly on the water, the present system uses a sanitary plastic liner (30) in conjunction with mechanical or sound vibration device (50) that stimulates the feet right through the tub. The sonic transmitter or transducer (50) is placed on the outside of the tub (20) and transmits sound vibrations through the tub (20) into the water and to the feet. By placing the vibration on the outside of the tub (20) allows for a plastic liner (30) to be placed inside the tub (20). The tub (20) is a closed system and water is kept totally within the tub (20). The tub (20) is kept sanitary by inserting the liner (30) between each use. This would not work with footbaths that have air or water jets.

The present system provides a pedicure soaking system that could give the same simulating effects as with water or air jets in the existing art, but without the potential disease problem that is associated with improper sanitization as in the existing art, or the plumbing requirements needed in whirlpool tubs. In addition to the cost of labor and time to clean the system after each use is substantially reduced.

In one embodiment of the present invention components consist of a tub (20), liner bag (30), bag retainer ring (31), and vibrator or transducer (50) attached to the bottom of the tub (20). One will note that the tub is sealed off from the vibrator (50) and the water is kept totally inside the tub and the liner. At no time does the massaging means (50) or the tub (20) come into direct contact with the fluid inside the liner (30). The plastic liner bag (30) is placed through the retainer ring (31) with the excess wrapped over the sides of the ring. Then the bag (30) and ring (31) is inserted into the tub (20) with the retainer ring (31) snugly fit at the top of the tub (20). The tub (20) is then prepared to fill with water or product. The customer's feet can now be inserted into the water and the power turned on to activate the vibrator or transducer (50).

In another embodiment there is disclosed a chair (70) which can adjust in height to allow varying lengths of customers' legs to reach bottom of tub (20) in cart (80). The cart (80) can be moved around easily like a small hand truck and locks in place when the front is dropped. Chair (70) can be either raised up or tilted back so the thighs and knees are supported while the feet are in the tub. This keeps the customer in an ergonomically pleasing position without his or her legs hyperextended as in most other pedicure systems. Not only is the top high enough to fit the knees under and sit on a normal chair or stool, but the under support is narrow enough for he knees of the therapist to straddle. The mechanical or sound vibration device (50) is attached to the bottom of the tub (20).

The present system has a potential broad use especially with the current problems in the pedicure industry of staff and tuberculosis infections caused by incomplete cleaning of tubs, filters, pumps, and hoses by nail technicians. With the present system there is a 100% complete sanitization every time with the introduction of the disposable plastic bags (30)—no water being contaminated by poorly disinfecting the tub (20). The plastic in effect is a prophylactic in that there is never water contact with a bare, pre-used tub; thus the applications will cover the entire Pedicure/Spa industries, Hospitals, Podiatrists and Consumers where fluid is used to “soak” the feet and at the same time massage action is desired to be applied.

The present system can be a table with a built in foot tub (20) like that disclosed in U.S. Pat. No. 6,739,003, or a chair with a foot tub placed near the floor, a fitted plastic bag that fits inside the tub, a sonic transmitter mounted on the outside (or inside) of the tub or a mechanical device for causing vibrations, and a bag spacer ring to allow the bag to fit neatly and be refolded inward or outward. The bag can be filled at a sink, or in place in the tub, and can be emptied in a sink or through a sink drain in the tub by means of puncturing the bag right over that drain. A rigid liner could be also be used to act like a bucket that could be lifted in and out of the tub. This bucket could be cleaned after each use thereby reducing the need for the liner.

The present invention offers many advantages over the current massage foot baths like: No stained tubs, oils can now be used since there is no worries about clean up or getting the oils out of the jets. The oils could also have clogged up or damaged the jets. No corrosion problems as with salts on pump components since the massaging device does not come into contact with the fluids in the tubs. No Disinfecting or cleanup required after each use of the footbath. The plastic liner is simply removed or a hole is punched in the bottom and the contents flow out through a drain in the bottom of the tub.

The spa owner can be free of worry since there can be no liability due to improper disinfecting by the technician and the patrons are safeguarded from disease transmission. As noted above, this system can be used with or without plumbing.

All references including patents and applications are expressly incorporated by reference in their entirety as if fully written herein.

Since obvious changes may be made in the specific embodiment of the invention described herein, each modification being the spirit and scope of the invention claimed, it is indicated that all matter contained herein is intended as illustrative and not limiting in scope.

I claim:

1. A massage footbath, comprising:
a sealed tub; and
an agitating device associated on the outside of said sealed tub.

2. A pedicure foot massage chair comprising;
a chair;
a sealed footbath at the bottom of said chair; and
an agitating device associated on the outside of said sealed tub but not in direct contact with any fluids in said tub and in capsule of agitating fluid in said tub or providing a massaging action directly to a patient's feet.

3. A table comprising;
a base frame;
a table top attached above said base frame, said table top having an upper support section, center support section and a caudal support section; and
a foot tub inside caudal support section of said table top; and
an indirect agitating device associated on the outside of said tub.

4. The foot tub as recited in claims 1 wherein said foot tub has a disposable liner insert into said foot tub.

5. The foot tub as recited in claims 2 wherein said foot tub has a disposable liner insert into said foot tub.

6. The foot tub as recited in claims 3 wherein said foot tub has a disposable liner insert into said foot tub.

7. The foot tub as recited in claims 4 herein said indirect agitating device is mechanical, transmitter or transducer.

8. The foot tub as recited in claims 5 herein said indirect agitating device is mechanical, transmitter or transducer.

9. The foot tub as recited in claims 6 herein said indirect agitating device is mechanical, transmitter or transducer.
